(19) United States
(12) Patent Application Publication
(10) Pub. No.: US 2021/0390867 A1
(43) Pub. Date: Dec. 16, 2021

(54) BIG DATA-BASED AUTONOMOUS FLIGHT DRONE SYSTEM AND AUTONOMOUS FLIGHT METHOD THEREFOR

(71) Applicant: RGBLAB CO., LTD., Daegu (KR)

(72) Inventors: Yong Dug KIM, Daegu (KR); Min Ji RYU, Daegu (KR)

(21) Appl. No.: 17/291,764

(22) PCT Filed: Oct. 31, 2019
(86) PCT No.: PCT/KR2019/014609

§ 371 Date: May 6, 2021

(30) Foreign Application Priority Data
Nov. 22, 2018 (KR) 10-2018-0145607

(51) Int. Cl. G08G 5/00; G05D 1/00; B64C 39/02

(52) U.S. Cl. CPC G08G 5/0043; G05D 1/0022; G08G 5/0039; G08G 5/006; B64C 2201/127; G08G 5/0008; B64C 39/024; B64C 2201/146; B64C 2201/141; G08G 5/0013

(57) ABSTRACT

There is provided is a big data-based autonomous flight drone system according to an exemplary embodiment of the present invention, which includes: a smart drone; a ground control system generating a remote control command for flight control of the smart drone; a drone IoT server which operates as a relay server for a communication connection between the smart drone and the ground control system, receives the remote control command from the ground control system so as to transfer the remote control command to the smart drone, and receives drone flight information and a camera image from the smart drone so as to transfer the drone flight information and the camera image to the ground control system; and an AI big data server which receives destination information and the drone flight information inputted in the ground control system, and generates a plurality of flight routes according to a preset criterion by interlocking with a database storing spatial information big data based on the destination information and the drone flight information, and provides the plurality of flight routes to the ground control system.

### TECHNICAL FIELD

The present invention relates to a big data-based autonomous flight drone system and autonomous flight method therefor.

### BACKGROUND ART

Drones, mainly used for initial military, as unmanned aircrafts that can fly and control by guidance of wireless radio wave without a pilot have been utilized in various fields such as logistics delivery, disaster relief, broadcasting, and leisure in addition to a military purpose due to various advantages such as convenience, quickness, and economics in recent years.

As such, the utilization and dissemination of the drones have been expanded due to various advantages of the drones and a case where the drones fall due to a change of an environmental change such as the wind and an inexperienced driving operation also often occurs, and in this case, there is a problem that significant economic damage is suffered due to breakage of expensive parts.

As a result, in recent years, there have been attempts to implement a smart drone which enables automatic flight by artificial intelligence, but in this case, more expensive parts cannot but be used in order to provide multiple sensors or communication devices or control modules which should be provided for autonomous flight in the drone, and as a result, there is a problem that there is a concern that economic loss which is suffered from breakage will still increase.

Further, since a user should operate the drone on the ground by using a remote controller up to now, the drone has a limit that a controllable range is limited within a field of view range of a user even though the drone is equipped with a camera, etc., and as a result, there is inconvenience that a use area is limited. Further, even though the field of view of the user is secured, there is a problem that remote flight is difficult due to a communication distance limit between the remote controller and the drone.

Further, existing drones have been able to fly only on a route predetermined by the user as autonomous flight utilizing GPS information, and a retention altitude during flight is retained to an altitude predetermined prior to flight, and as a result, there is a risk that the drone will collide with a building. Moreover, there is a problem that building avoidance flight depends on an additional device such as a vision or a Lidar sensor and flight prohibited area avoidance flight is limited only to a predetermined area.

Therefore, an easy control technology (one-point autonomous flight) capable of controlling the drone only when inputting only a destination on a map regardless of a control proficiency of the user is required and in addition, long-term evolution (LTE) communication-based long-range flight is required in a remote place of a non-visible range in order for the drone to perform a mission.

### DISCLOSURE

### Technical Problem

An aspect of the present invention provides a big data-based autonomous flight drone system and autonomous flight method therefor which generate the best flight route up to a destination with a current location of a drone as a departure point based on spatial information big data to remotely control autonomous flight of the drone up to a flight destination regardless of a control proficiency of a user based on a one-point autonomous flight technology.

### Technical Solution

According to an aspect of the present invention, there is provided a big data-based autonomous flight drone system according to an exemplary embodiment of the present invention, which includes: a smart drone; a ground control system generating a remote control command for flight control of the smart drone; a drone IoT server which operates as a relay server for a communication connection between the smart drone and the ground control system, receives the remote control command from the ground control system so as to transfer the remote control command to the smart drone, and receives drone flight information and a camera image from the smart drone so as to transfer the drone flight information and the camera image to the ground control system; and an AI big data server which receives destination information and the drone flight information inputted in the ground control system through the drone IoT server, and generates a plurality of flight routes according to a preset criterion by interlocking with a database storing spatial information big data based on the destination information and the drone flight information, and provides the plurality of flight routes to the ground control system.

The ground control system may display the plurality of flight routes generated by the AI big data server on a screen to guide a user to select any one of the plurality of flight routes, and when any one of the plurality of flight routes is selected, generate the remote control command including the selected flight route.

The drone IoT server may transfer the remote control command to the smart drone through LTE mobile communication network-based bidirectional communication with the smart drone, and receive drone flight information and a camera image from the smart drone and transfer the drone flight information and the camera image to each of the AI big data server and the ground control system.

The spatial information big data may include at least one of building position information, and information on a flight prohibited area, a densely populated area, and an LTE degraded area, and the AI big data server may analyze a flight route from a departure point which is a current position of the smart drone up to a destination through digitization of spatial information based on the spatial information big data and determine whether a flight prohibited area is included in the flight route, and when determining that the flight prohibited area is included in the flight route, update the flight route by making a flight permitted area capable of detouring the flight prohibited area be included in the flight route.

The ground control system may receive an update notification signal for the update of the flight route from the AI big data server, and display the updated flight route on the screen in response to the update notification signal and guide the user to select any one of the updated flight routes, and when any one of the updated flight routes is selected, update the remote control command by reflecting the selected flight route and transfer the updated remote control command to the smart drone through the drone IoT server.

When the smart drone receives the remote control command from the ground control system through the drone IoT server, the smart drone may share the remote control command by sharing communication with at least one other drone located within a predetermined distance based on the current position of the smart drone to perform a swarm flight with the at least one other drone.

The spatial information big data may further include drone position information, and the AI big data server may determine whether there is another drone located on the flight route of the smart drone based on the drone position information by interlocking with the database, and when determining that there is another drone, transmit positional information of another drone and flight detour route information at the corresponding position to the ground control system, and the ground control system may display and guide the positional information of another drone and the flight detour route information at the corresponding position on the screen so that the user is capable of selecting whether to change the flight route of the smart drone at the position where there is another drone.

According to another aspect of the present invention, there is provided a big data-based autonomous flight method which includes: generating, by an AI big data server, a plurality of flight routes according to a preset criterion by interlocking with a database storing spatial information big data based on destination information and drone flight information of a smart drone inputted in a ground control system; receiving, by the ground control system, the plurality of flight routes through the drone IoT server, and displaying the plurality of flight routes on a screen to guide a user to select any one of the plurality of flight routes; when any one of the plurality of flight routes is selected, generating, by the ground control system, a remote control command including the selected flight route; and receiving, by a drone IoT server, the remote control command from the ground control system, transferring the remote control command to the smart drone through LTE mobile communication network-based bidirectional communication with the smart drone, and receiving the drone flight information and a camera image from the smart drone and transferring the drone flight information and the camera image to each of the AI big data server and the ground control system.

Detailed contents of other exemplary embodiments are included in the detailed description and the accompanying drawings.

### Advantageous Effects

As set forth above, according to exemplary embodiments of the present invention, the best flight route up to a destination with a current location of a drone as a departure point is generated based on spatial information big data to remotely control autonomous flight of the drone up to a flight destination regardless of the control proficiency of a user based on a one-point autonomous flight technology.

### DESCRIPTION OF DRAWINGS

FIG. 1 is a system configuration diagram illustrated for describing a big data-based autonomous flight drone system according to an exemplary embodiment of the present invention;

FIGS. 2 and 3 are diagrams illustrated to compare a conventional communication method and a communication method of the present invention;

FIGS. 4 and 5 are diagrams illustrated to compare a conventional autonomous flight route extraction method and an autonomous flight route extraction method using big data of the present invention;

FIG. 6 is a diagram illustrating an example of a flight technology of tracking an autonomous driving vehicle in an exemplary embodiment of the present invention;

FIG. 7 is a flowchart illustrated to describe a big data-based autonomous flight method according to an exemplary embodiment of the present invention;

FIG. 8 is a flowchart illustrated to describe a big data-based autonomous flight method according to another exemplary embodiment of the present invention; and

FIG. 9 is a flowchart illustrated to describe a big data-based autonomous flight method according to yet another exemplary embodiment of the present invention.

### MODE FOR INVENTION

Advantages and/or features of the present invention, and a method for achieving the advantages and/or features will become obvious with reference to exemplary embodiments to be described below in detail together with the accompanying drawings. However, the present invention is not limited to the exemplary embodiments set forth below, and will be embodied in various different forms. The exemplary embodiments are just for rendering the disclosure of the present invention complete and are set forth to provide a complete understanding of the scope of the invention to a person with ordinary skill in the technical field to which the present invention pertains, and the present invention will only be defined by the scope of the claims. Like reference numerals refer to like elements throughout the specification.

In addition, the preferred embodiments of the present invention implemented below are previously included in each system function component in order to effectively describe the technical components of the present invention or as far as possible, the system function component generally possessed in the technical field of the present invention is omitted, and the description is mainly for a function component which should be additionally provided. Those skilled in the art in the technical field to which the present invention pertains will be able to easily understand the functions of the previously used components in the omitted functional components not illustrated below and further, will be able to also clearly understand a relationship between the omitted components and components added for the present invention.

In addition, in the following description, “transmission”, “communication”, “send”, “receive”, and other terms with similar meanings thereto also include direct transfer to of signals or information from one component to another component and transfer through another component. In particular, “transmitting” or “sending” the signals or information to one component indicates a final destination of the signal or information and does not mean a direct destination. This is similar even in “receiving” the signal or information.

Exemplary embodiments of the present invention will now be described in detail with reference to the accompanying drawings.

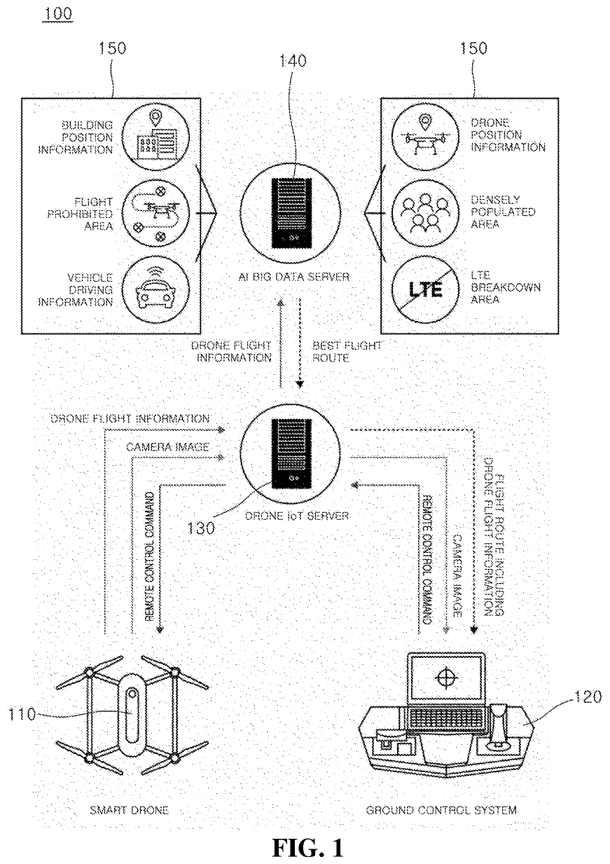

FIG. 1 is a system configuration diagram illustrated for describing a big data-based autonomous flight drone system according to an exemplary embodiment of the present invention.

Referring to FIG. 1, a big data-based autonomous flight drone system 100 according to an exemplary embodiment of the present invention may be configured to include a smart drone 110, a ground control system 120, a drone IoT server 130, an AI big data server 140, and a database 150.

The smart done 110 communicates with the drone IoT server 130 to indirectly receive a remote control command for flight control of the smart drone 110 from the ground control system 120 and fly a flight route according to the remote control command.

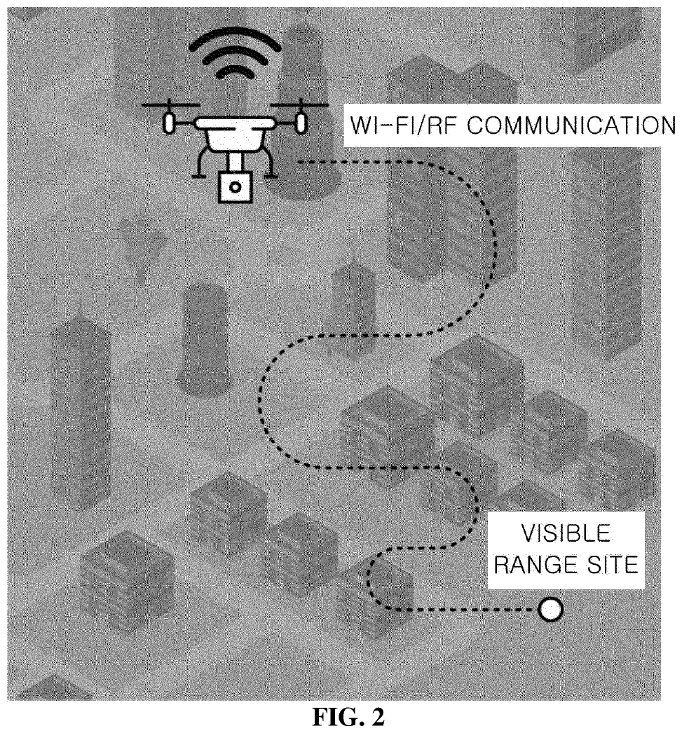

The smart drone 110 may use at least one of various wireless communication methods with the drone IoT server 130, e.g., communication using a radio frequency, and Bluetooth™, Wireless LAN, Radio Frequency Identification (RFID), Infrared Data Association (IrDA), Ultra Wideband (UWB), ZigBee, Near Field Communication (NFC), WirelessFidelity (Wi-Fi), Wi-Fi Direct, and Wireless Universal Serial Bus (Wireless USB) technologies. For reference, FIG. 2 illustrates that the smart drone 110 performs wireless communication with the drone IoT server 130 by using an existing wireless communication method such as Wi-Fi/RF communication.

However, since the conventional wireless communication method is a short-range communication method, there is no problem in performing a short-distance mission by the smart drone 110, but there is a problem that the conventional wireless communication method is not suitable for the smart drone 110 to perform a long-distance mission.

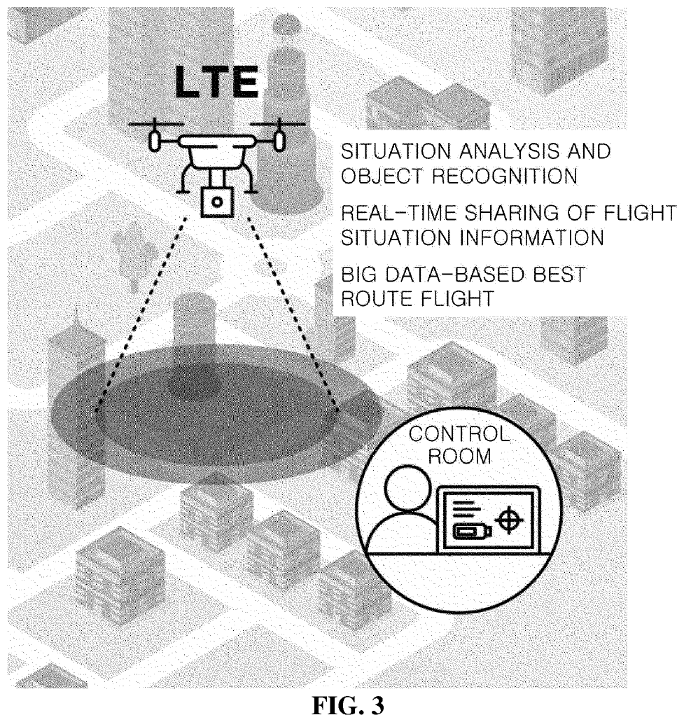

Therefore, in an exemplary embodiment of the present invention, as illustrated in FIG. 3, the smart drone 110 may transmit and receive data to and from the drone IoT server 130 through long term evolution (LTE) mobile communication network-based bidirectional communication which is a wireless communication method suitable for the smart drone to perform the long-distance mission. Thus, the smart drone 110 may perform situation analysis and object recognition (AI), flight situation information (telemetry) real-time sharing, autonomous flight according to big data-based best flight route selection of a user (control worker), etc.

The user (control worker) may transfer a flight-related remote control command, etc., to the smart drone 110 through a ground control system (GCS) 120 and receive a camera image or a route camera image from the smart drone 110.

The smart drone 110 is dispatched to a mission site for initial observation or mission execution to photograph images for a flight route surrounding environment and the mission site or collect mission-related information through a sensor, etc. In other words, the smart drone 110 is first dispatched to a site where the mission execution is required or a site where an accident occurs before a site worker reaches the corresponding site, to photograph an image related to a mission or collect information (mission-related information) required for the mission execution.

In this case, the smart drone 110 may photograph the image for the flight route surrounding environment and the mission site or collect the mission-related information in all processes up to a time of reaching and returning from a time of being dispatched to the mission site. The smart drone 110 may transmit the photographed image for the mission site and the mission-related information to the ground control system 120 through the drone IoT server 130 in real time.

For example, when a mission which the smart drone 110 should perform is fire suppression or fire monitoring, before a firefighter who is an on-site staff arrives at a site, the smart drone 110 is first dispatched to the site of the fire to photograph a real-time image on the fire site or around the fire site and transmit the photographed image to the ground control system 120 through the drone IoT server 130 in real time. Further, the smart drone 110 may collect mission-related information including weather information such as a temperature, humidity, a wind speed, and a wind direction of a flight route surrounding environment or the mission site through various sensors, and transmit the collected mission-related information to the ground control system 120 through the drone IoT server 130 in real time.

To this end, the smart drone 110 receives a remote control command including location information (destination information) and flight route information related to the site from the ground control system 120 through the drone IoT server 130, and performs the fight control on the corresponding flight route according to the received remote control command, thereby reaching the site.

Specifically, the smart drone 110 may receive the remote control command through LTE mobile communication network-based wireless communication with the drone IoT server 130, and control the flight of the smart drone 110 in an autonomous flight mode according to the received remote control command. Here, the flight route information included in the remote control command may include a flight route which the user selects through an input operation of the ground control system 120 among a plurality of flight routes generated by an AI big data server 140 to be described below.

When the smart drone 110 receives the remote control command from the ground control system 120 through the drone IoT server 130, the smart drone 110 may share the remote control command by performing communication with at least one other drone located within a predetermined distance based on a current position of the smart drone 110. As a result, the smart drone 110 may perform swarm flight with at least one other drone according to the remote control command. In this case, communication between respective drones may be performed through an LTE mobile communication method, and a distance (interval) between the respective drones may be set so that viewing angles of the respective drones overlap with each other.

Further, the smart drone 110 may transmit drone flight information acquired in a flight process, which includes a flight route, a flight altitude, positional information with other drones, and the like to the AI big data server 140 through the drone IoT server 130 in real time.

The ground control system 120 may receive information on the destination or the flight route according to a manual operation of the user (control worker). The ground control system 120 may transmit the information on the destination and information on the current position of the smart drone to the AI big data server 140. Here, the information on the current position of the smart drone may initially indicate predetermined positional information, but then, indicate the current position information included in the drone flight information transferred from the smart drone 110 through the drone IoT server 130 in real time.

The drone IoT server 130 may operate as a relay server for a communication connection between the smart drone 110 and the ground control system 120. That is, the drone IoT server 130 may receive the remote control command from the ground control system 120 and transfer the received remote control command to the smart drone 110, and receive a camera image from the smart drone 110 and transfer the received camera image to the ground control system 120. Further, the drone IoT server 130 may receive the drone flight information from the smart drone 110 and transfer the received drone flight information to the AI big data server 140.

To this end, the drone IoT server 130 may perform the LTE mobile communication network-based bidirectional communication with the smart drone 110. In other words, the drone IoT server 130 may receive the remote control command from the ground control system 120 and transfer the received remote control command to the smart drone 110 through the LTE mobile communication network-based bidirectional communication with the smart drone 110, and receive the drone height information and the camera image from the smart drone 110 and transfer the drone flight information to the AI big data server 140, and transfer the camera image to the ground control system 120.

The AI big data server 140 may receive destination information inputted in the smart drone 110 through the ground control system 120 and the drone height information generated by the smart drone 110 through the drone IoT server 130. Here, the AI big data server 140 may continuously receive the drone height information of the smart drone 110 from the drone IoT server 140 in order to continuously enable updating spatial information big data. As a result, the AI big data server 120 may reconfigure the spatial information big data by interlocking with the database 150 based on the drone height information.

For reference, the spatial information is generally positional information for a natural or artificial object which exists in a space such as on the ground, underground, on the water, in the water, etc., and information required for spatial recognition and decision making related thereto. In the present invention, the positional information for the natural or artificial object which exists on the ground and the information required for the spatial recognition and decision making related thereto may be used as the spatial information.

The AI big data server 140 may generate a plurality of flight routes according to a predetermined criterion (e.g., a shortest distance, a minimum time, etc.) by interlocking with the database 150 storing the spatial information big data based on the destination information and the drone flight information, and provide the generated flight routes to the ground control system 120 through the drone IoT server 130. As a result, the ground control system 120 may guide the user to select any one of the plurality of flight routes by displaying the plurality of flight routes generated by the AI big data server 140 on a screen, and when any one of the plurality of flight routes is selected, generate the remote control command including the selected flight route and transfer the generated remote control command to the smart drone 110 through the drone IoT server 130.

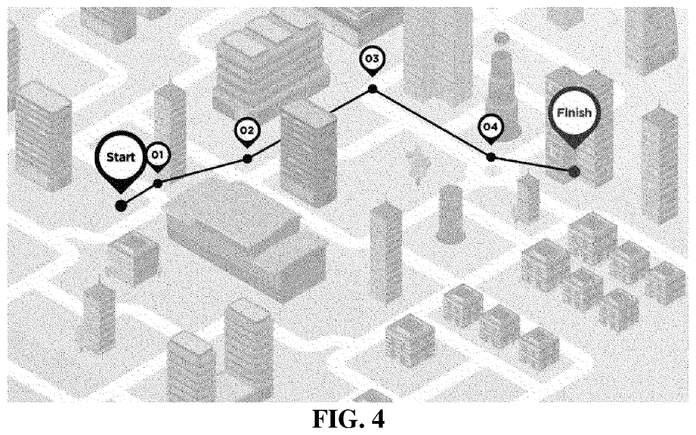

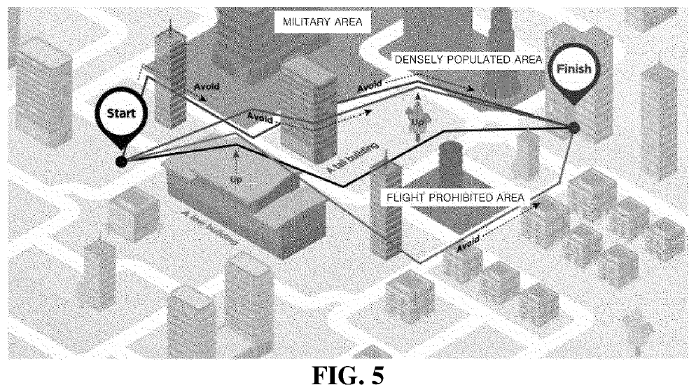

For example, the spatial information big data may include information on building position information, flight prohibited areas, densely populated areas, LTE degraded areas, and the like. However, in the conventional invention, as illustrated in FIG. 4, since the spatial information big data is not utilized, only a simple flight route is provided. However, in the case of the present invention, as illustrated in FIG. 5, the AI big data server 140 avoids military areas, densely populated areas, flight prohibited areas, etc., or increases (up) the altitude in high-rise buildings by utilizing the spatial information big data, thereby generating the best flight route. In other words, the AI big data server 140 may generate the best flight route (shortest distance, minimum time, optimal altitude, etc.) for providing an active autonomous flight technology using the spatial information big data. Thus, according to an exemplary embodiment of the present invention, it is possible to provide a flight technology that actively generates the best flight route such as a minimum time flight route, a shortest distance flight route, etc., according to the mission, and provide an ideal altitude flight technology using information on a position, a height, etc., of a building which exists on the generated best flight route (building position information).

To this end, the AI big data server 140 analyzes a flight route from a departure point which is the current position of the smart drone 110 up to the destination through digitization of the spatial information based on the spatial information big data to determine whether the flight prohibited area or the LTE degraded area is included in the flight route.

Specifically, the AI big data server 140 divides a map containing the flight route of an analysis target into a plurality of grid-shape areas, and assigns identification numbers to the plurality of areas, respectively, and match the plurality of areas with actual coordinate values of the corresponding areas, and then outputs the identification number of an area determined as the flight prohibited area through coordinate analysis of the flight route using the spatial information big data to determine the area of the corresponding identification number as the flight prohibited area. Here, the flight prohibited area is a concept including an unexpected densely populated area (e.g., a gathering area, etc.) or an area where there are unexpected buildings on the flight route included in the previous remote control command.

When it is determined that the flight prohibited area is included in the flight route, the AI big data server 140 may update the flight route by making a flight permitted area capable of detouring the flight prohibited area be included in the flight route. Here, the flight permitted area may be derived by utilizing the spatial information big data.

As a result, the ground control system 120 may receive an update notification signal for the update of the flight route from the AI big data server 140 through the drone IoT server 130, display the updated flight route on the screen in response to the update notification signal and guide the user to select any one of the updated flight routes, and when any one of the updated flight routes is selected, update the remote control command by reflecting the selected flight route and transfer the updated remote control command to the smart drone 110 through the drone IoT server 130.

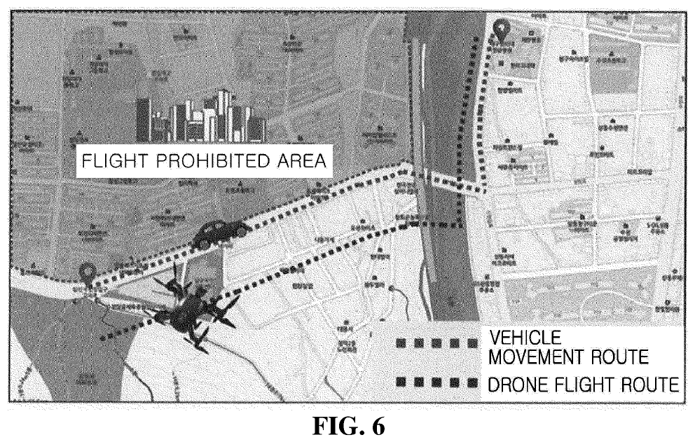

Meanwhile, the spatial information big data may also include driving information of an autonomous vehicle. In this case, as illustrated in FIG. 6, the AI big data server 140 may extract driving information of an autonomous vehicle located within a predetermined distance based on the current position of the smart drone 110 by interlocking with the database 150, and generate or update the flight route of the smart drone 110 based on the extracted driving information and provide the generated or updated flight route to the ground control system 120 through the drone IoT server 130.

Thus, the ground control system 120 may display the flight route corresponding to the driving information of the autonomous vehicle on the screen and guide the user to select the flight route, and when the flight route corresponding to the driving information of the autonomous vehicle is selected, generate the remote control command so that the smart drone 110 may control the flight along a driving route of the autonomous vehicle.

Unlike this, the smart drone 110 may perform the bidirectional communication directly with the autonomous vehicle(s) located within a predetermined distance based on the current position through the LTE mobile communication network. In other words, the smart drone 110 may transmit a driving information request signal for requesting the driving information to the autonomous vehicle(s) through the LTE mobile communication network, and receive the driving information of the corresponding autonomous vehicle(s) from the autonomous vehicle(s) through the LTE mobile communication network in response to the driving information request signal.

As a result, the ground control system 120 or the AI big data server 140 receives the driving information from the smart drone 110 through the drone IoT server 130, and generates a movement route of the autonomous vehicle(s) based on the received driving information and displays the generated movement route on the map on the screen together with the flight route of the smart drone 110 to guide the user to change and select the flight route of the smart drone 110 to the movement route of the autonomous vehicle(s) and thus enables flight route change(update) of the drone in real time to enable tracking the flight route of the smart drone with the position of the autonomous vehicle.

On the other hand, the spatial information big data may further include drone position information. In this case, the AI big data server 140 may determine whether there is another drone located on the flight route of the smart done 110 based on the drone position information by interlocking with the database 150 and when determining that there is another drone, transmit positional information of another drone and flight detour route information at the corresponding position to the ground control system 120 through the drone IoT server 130.

As a result, the ground control system 120 may display and guide the positional information of another drone and the flight detour route information at the corresponding position on the screen so that the user selects whether to change the flight route of the smart drone 110 at the position where there is another drone.

Unlike this, the smart drone 110 may perform the bidirectional communication directly with another drone (s) located within a predetermined distance based on the current position through the LTE mobile communication network in real time. In other words, the smart drone 110 may transmit a flight information request signal for requesting the drone flight information to another drone(s) through the LTE mobile communication network, and receive the flight information of the corresponding drone(s) from another drone(s) through the LTE mobile communication network in response to the flight information request signal.

The smart drone 110 may transfer the received flight information of another drone(s) to the AI big data server 140 through the drone IoT server 130.

As a result, the ground control system 120 receives the drone flight information from the AI big data server 140 or the smart drone 110 through the drone IoT server 130, and generates the flight route of another drone(s) based on the received drone flight information and displays the generated flight route on the map on the screen together with the flight route of the smart drone 110 to guide the user to change and select the flight route of the smart drone 110 to the flight route of another drone(s) and thus enable flight route change(update) of the drone in real time.

The database 150 may store spatial information big data related to autonomous flight control of the smart drone 110. That is, the database 150 may include a drone position information database (DB) storing positional information (latitude, longitude, height, etc.) of the drone, a building position information DB storing positional information (latitude, longitude, height, etc.) of the building, a flight prohibited area DB storing information on the flight prohibited area such as a military area, etc., a densely populated area DB storing information on the densely populated area such as a downtown area, an LTE degraded area DB storing information on the LTE degraded area, and the like. In addition, the database 150 may further include a driving information DB storing driving information of an autonomous vehicle located within a predetermined distance based on the current position of the smart drone 110 and a flight information DB storing flight information of another drone located within a predetermined distance based on the current position of the smart drone 110.

The devices described above may be implemented by hardware components, software components, and/or combinations of the hardware components and the software components. For example, the devices and components described in the exemplary embodiments may be implemented by using one or more universal computers or special-purpose computers such as a processor, a controller, an arithmetic logic unit (ALU), a digital signal processor, a microcomputer, a field programmable array (FPA), a programmable logic unit (PLU), a microprocessor, or any other device capable of executing and responding to an instruction. A processing device may perform an operating system (OS) and one or more software applications executed on the operating system. Further, the processing device may access, store, operate, process, or generate data in response to execution of software. For convenience of understanding, there is a case where it is described that one processing device is used, but those skilled in the art may know that the processing device may include a plurality of processing elements and/or a plurality of types of processing elements. For example, the processing device may include a plurality of processors or one or more processors or one controller. Further, another processing configuration such as a parallel processor is also available.

The software may include a computer program, code, instructions, or a combination of one or more thereof, and configure the processing device to operate as desired, or instruct a processing device independently or collectively. Software and/or data may be interpreted by the processing device or may be permanently or temporarily embodied in any type of machine, component, physical device, virtual equipment, computer storage medium or device, or a transmitted signal wave in order to provide instructions or data to the processing device. The software may be distributed on a computer system connected through the network and stored or executed by a distributed method. The software and the data may be stored in one or more computer-readable recording media.

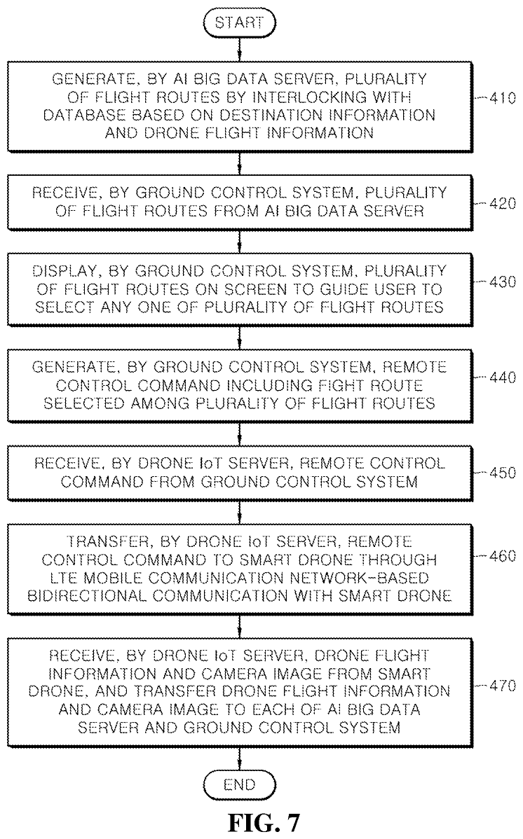

FIG. 7 is a flowchart illustrated to describe a big data-based autonomous flight method according to an exemplary embodiment of the present invention.

The big data-based autonomous flight method described herein is just one exemplary embodiment of the present invention and besides, various steps may be added as necessary, and the following steps may be executed by changing an order of the steps, and as a result, the present invention is not limited to each step described below and an order thereof. This may be similarly applied even to other exemplary embodiments below.

Referring to FIGS. 1 and 7, in step 410, the AI big data server 140 may generate a plurality of flight routes according to a preset criterion by interlocking with the database 150 storing the spatial information big data based on destination information inputted in the ground control system 120 and the drone flight information of the smart drone 110. Here, the destination information may include mission-related information which the smart drone 110 should perform at the destination.

Next, in step 420, the ground control system 120 may receive the plurality of flight routes from the AI big data server 140.

Next, in step 430, the ground control system 120 displays the plurality of flight routes on the screen to guide the user to select any one of the plurality of flight routes. For example, the ground control system 120 displays a best flight route A depending on the criterion of the minimum time, a best flight route B depending on the criterion of the shortest distance, etc., on the map of the screen to guide the user to select any one of the best flight routes A and B.

Next, in step 440, when any one of the plurality of flight routes is selected, the ground control system 120 may generate a remote control command including the selected flight route.

Next, in step 450, the drone IoT server 130 may receive the remote control command from the ground control system 120.

Next, in step 460, the drone IoT server 130 may transfer the remote control command to the smart drone 110 through the LTE mobile communication network-based bidirectional communication with the smart drone 110.

Next, in step 470, the drone IoT server 130 may receive the drone flight information and the camera image from the smart drone 110 and transfer the received drone flight information and camera image to each of the AI big data server 140 and the ground control system 120.

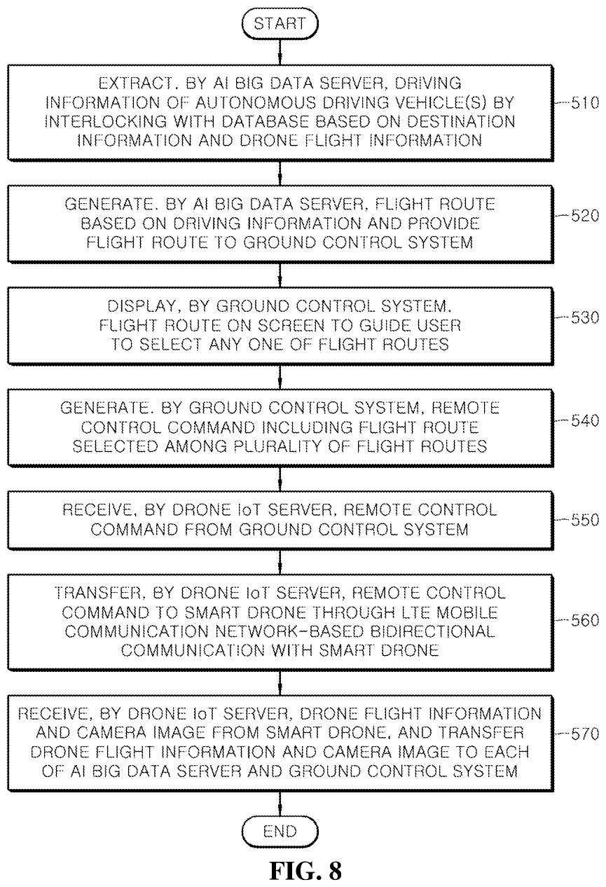

FIG. 8 is a flowchart illustrated to describe a big data-based autonomous flight method according to another exemplary embodiment of the present invention.

Referring to FIGS. 1 and 8, in step 510, the AI big data server 140 may extract the driving information of the autonomous vehicle(s) located within a predetermined distance based on the current position of the smart drone 110 by interlocking with the database 150 storing the spatial information big data based on the destination information inputted in the ground control system 120 and the drone flight information of the smart drone 110.

Next, in step 520, the AI big data server 140 may generate the flight route of the smart drone 110 based on the extracted driving information and provide the generated flight route to the ground control system 120.

Next, in step 530, the ground control system 120 displays the flight route on the screen to guide the user to select any one of the flight routes.

Next, in step 540, when any one of the plurality of flight routes is selected, the ground control system 120 may generate a remote control command including the selected flight route.

Next, in step 550, the drone IoT server 130 may receive the remote control command from the ground control system 120.

Next, in step 560, the drone IoT server 130 may transfer the remote control command to the smart drone 110 through the LTE mobile communication network-based bidirectional communication with the smart drone 110.

Next, in step 570, the drone IoT server 130 may receive the drone flight information and the camera image from the smart drone 110 and transfer the received drone flight information and camera image to each of the AI big data server 140 and the ground control system 120.

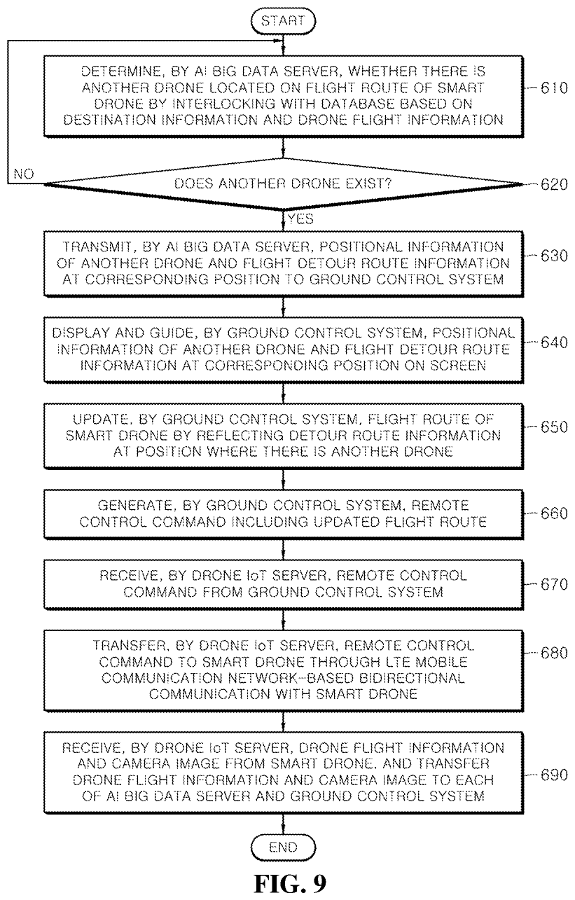

FIG. 9 is a flowchart illustrated to describe a big data-based autonomous flight method according to yet another exemplary embodiment of the present invention.

Referring to FIGS. 1 and 9, in step 610, the AI big data server 140 may determine whether there is another drone located on the flight route of the smart drone 110 by interlocking with the database 150 storing the spatial information big data based on destination information inputted in the ground control system 120 and the drone flight information of the smart drone 110.

According to the determination result, when there is another drone located on the flight route of the smart drone 110 (“Yes” direction of step 620), the AI big data server 140 may transmit positional information of another drone and flight detour route information at the corresponding position to the ground control system 120 in step 630.

Next, in step 640, the ground control system 120 may display and guide the positional information of another drone and the flight detour route information at the corresponding position on the screen so that the user selects whether to change the flight route of the smart drone 110 at the position where there is another drone.

Next, in step 650, when the flight route change of the smart drone 110 is selected by the input operation of the user, the ground control system 120 may update the flight route of the smart drone 110 by reflecting the detour route information at the position where there is another drone.

Next, in step 660, the ground control system 120 may generate a remote control command including the updated flight route.

Next, in step 670, the drone IoT server 130 may receive the remote control command from the ground control system 120.

Next, in step 680, the drone IoT server 130 may transfer the remote control command to the smart drone 110 through the LTE mobile communication network-based bidirectional communication with the smart drone 110.

Next, in step 690, the drone IoT server 130 may receive the drone flight information and the camera image from the smart drone 110 and transfer the received drone flight information and camera image to each of the AI big data server 140 and the ground control system 120.

The method according to the exemplary embodiment may be implemented in a form of a program command which may be performed through various computer means and recorded in the computer-readable medium. The computer-readable medium may include singly or a program command, a data file, or a data structure or a combination thereof. The program command recorded in the medium may be specially designed and configured for the exemplary embodiment, or may be publicly known to and used by those skilled in the computer software field. An example of the computer-readable recording medium includes magnetic media, such as a hard disk, a floppy disk, and a magnetic tape, optical media such as a CD-ROM and a DVD, magneto-optical media such as a floptical disk, and all types of hardware devices such as a ROM, a RAM, and a flash memory, which are specially configured to store and execute the program command. An example of the program command includes a high-level language code executable by a computer by using an interpreter and the like, as well as a machine language code created by a compiler. The hardware device may be configured to be operated with one or more software modules in order to perform the operation of the exemplary embodiment and vice versa.

As described above, although the exemplary embodiments have been described by the limited exemplary embodiments and drawings, those skilled in the art can perform various technical modifications and variations from the description. For example, the described techniques are performed in a different order from the described method, and/or components such as a system, structure, device, circuit, etc., described are connected or combined in a form different from the described method, or even if the components are replaced or substituted by other components or an equivalent, an appropriate result can be achieved.

Therefore, other implementations, other exemplary embodiments and equivalents to the claims also fall within the scope of the claims to be described below.

1. A big data-based autonomous flight drone system comprising:
a smart drone;
a ground control system generating a remote control command for flight control of the smart drone;
a drone IoT server which operates as a relay server for a communication connection between the smart drone and the ground control system, receives the remote control command from the ground control system so as to transfer the remote control command to the smart drone, and receives drone flight information and a camera image from the smart drone so as to transfer the drone flight information and the camera image to the ground control system; and
an AI big data server which receives destination information and the drone flight information inputted in the ground control system through the drone IoT server, and generates a plurality of flight routes according to a preset criterion by interlocking with a database storing spatial information big data based on the destination information and the drone flight information, and provides the plurality of flight routes to the ground control system.

2. The big data-based autonomous flight drone system of claim 1, wherein the ground control system displays the plurality of flight routes generated by the AI big data server on a screen to guide a user to select any one of the plurality of flight routes, and when any one of the plurality of flight routes is selected, generates the remote control command including the selected flight route.

3. The big data-based autonomous flight drone system of claim 1, wherein the drone IoT server transfers the remote control command to the smart drone through LTE mobile communication network-based bidirectional communication with the smart drone, and receives drone flight information and a camera image from the smart drone and transfers the drone flight information and the camera image to each of the AI big data server and the ground control system.

4. The big data-based autonomous flight drone system of claim 1, wherein the spatial information big data includes at least one of building position information, and information on a flight prohibited area, a densely populated area, and an LTE degraded area, and
the AI big data server analyzes a flight route from a departure point which is a current position of the smart drone up to a destination through digitization of spatial information based on the spatial information big data and determines whether a flight prohibited area is included in the flight route, and when determining that the flight prohibited area is included in the flight route, updates the flight route by making a flight permitted area capable of detouring the flight prohibited area be included in the flight route.

5. The big data-based autonomous flight drone system of claim 4, wherein the ground control system receives an update notification signal for the update of the flight route from the AI big data server, and displays the updated flight route on the screen in response to the update notification signal and guides the user to select any one of the updated flight routes, and when any one of the updated flight routes is selected, updates the remote control command by reflecting the selected flight route and transfers the updated remote control command to the smart drone through the drone IoT server.

6. The big data-based autonomous flight drone system of claim 1, wherein when the smart drone receives the remote control command from the ground control system through the drone IoT server, the smart drone shares the remote control command by sharing communication with at least one other drone located within a predetermined distance based on the current position of the smart drone to perform a swarm flight with the at least one other drone.

7. The big data-based autonomous flight drone system of claim 1, wherein the spatial information big data further includes drone position information, and
the AI big data server determines whether there is another drone located on the flight route of the smart drone based on the drone position information by interlocking with the database, and when determining that there is another drone, transmits positional information of the another drone and flight detour route information at the corresponding position to the ground control system, and
the ground control system displays and guides the positional information of the another drone and the flight detour route information at the corresponding position on the screen so that the user is capable of selecting whether to change the flight route of the smart drone at the position where there is the another drone.

8. A big data-based autonomous flight method using a big data-based autonomous flight drone system including a smart drone, a ground control system, a drone IoT server, and an AI big data server, the method comprising:
generating, by the AI big data server, a plurality of flight routes according to a preset criterion by interlocking with a database storing spatial information big data based on destination information and drone flight information of the smart drone inputted in the ground control system;
receiving, by the ground control system, the plurality of flight routes from the AI big data server, and displaying the plurality of flight routes on a screen to guide a user to select any one of the plurality of flight routes;
when any one of the plurality of flight routes is selected, generating, by the ground control system, a remote control command including the selected flight route; and
receiving, by the drone IoT server, the remote control command from the ground control system, transferring the remote control command to the smart drone through LTE mobile communication network-based bidirectional communication with the smart drone, and receiving the drone flight information and a camera image from the smart drone and transferring the drone flight information and the camera image to each of the AI big data server and the ground control system.

9. The big data-based autonomous flight method of claim 8, wherein the generating of the flight route includes,
dividing a map including the flight route up to a destination from a departure point which is a current position of the smart drone into a plurality of grid-shape areas,
assigning identification numbers to the plurality of areas, respectively and matching the plurality of areas with actual coordinate values of the corresponding areas, and then outputting the identification number of an area determined as a flight prohibited area through coordinate analysis of the flight route using the spatial information big data to determine the area of the corresponding identification number as the flight prohibited area, and
when it is determined that the flight prohibited area is included in the flight route, updating the flight route by making a flight permitted area capable of detouring the flight prohibited area be included in the flight route.
